(19) United States
(12) Patent Application Publication
(10) Pub. No.: US 2016/0077281 A1
(43) Pub. Date: Mar. 17, 2016

(54) VARIABLE OPTICAL ATTENUATOR WITH WAVELENGTH-DEPENDENT LOSS COMPENSATION

(71) Applicant: BROWAVE CORPORATION, Hsinchu (TW)

(72) Inventors: Jung-Tsung CHOU, Hsinchu (TW); Kuo-Hsuan HUNG, Hsinchu (TW); Yu-Wen HWANG, Hsinchu (TW)

(73) Assignee: BROWAVE CORPORATION, Hsinchu (TW)

(21) Appl. No.: 14/485,102

(22) Filed: Sep. 12, 2014

(51) Int. Cl. G02B 6/26; G02B 26/02; G02B 26/08; G02B 6/32

(52) U.S. Cl. CPC G02B 6/266; G02B 6/327; G02B 26/02; G02B 26/0816; G02B 6/32

(57) ABSTRACT

A variable optical attenuator with wavelength-dependent loss compensation is provided, including: an optical fiber pigtail comprising at least a first waveguide and a second waveguide; a lens being disposed between the optical fiber pigtail and a reflector for focusing an emitted light from the first waveguide and returning a reflected light from the reflector to the second waveguide of the optical fiber pigtail; and the reflector being disposed at the focus of the lens to reflect the emitted light from the first waveguide passing the lens, and the reflected light passing through the lens to return to the second waveguide, the reflector having an initial position with a normal forming a pre-tilt angle with the axis of lens in the incident plane defined by the two axes, and the reflector tilting towards a larger tilt angle when an attenuation value increasing.

### TECHNICAL FIELD

The technical field generally relates to a variable optical attenuator with wavelength-dependent loss compensation.

### BACKGROUND

The ever-increasing demands on communication propel the rapid development of a wide range of communication technologies. Among those, the optical communication has been a focal point for more than two decades. In addition to optical fiber deployment, various techniques are also developed to increase the utilization and efficiency of the optical fiber. For example, Wavelength Division Multiplexing (WDM) transmits a plurality of optical signals of different wavelengths to improve the transmission capacity.

When a variable attenuator is applied to optical WDM system, a common requirement is to provide a consistent attenuation to the signals of different wavelengths. At present, a popular technique is variable optical attenuator (VOA) made with Micro-electro-mechanical-system (MEMS) chip and fiber optics. The MEMS VOA often employs tilt reflector for attenuation. In other words, an incident optical fiber uses a small reflector to guide the optical light to another emitting optical fiber. When the small reflector is tilted, a part of the optical light is unable to couple to the emitting optical fiber, which achieves optical attenuation.

Even with its popularity, the flat-mirror reflection-type MEMS VOA is far from perfect. As the attenuation increases, signals of different wavelengths will experience different attenuation at the same tilt angle. In other words, the attenuation is wavelength-dependent. An index, called wavelength-dependent loss (WDL), is a measurement of how uniformly different wavelengths are attenuated at a certain attenuation value. WDL is used to depict a maximum difference in attenuation value for signals of different wavelengths at a certain attenuation value. For example, when an expected attenuation is 20 dB, and the actual maximum attenuation is 20.6 dB at 1525 nm and minimum attenuation is 19.4 dB at 1575 nm, the WDL at attenuation 20 dB is 1.2 dB (=20.6-19.4). For a known flat-mirror reflection-type MEMS VOA without WDL compensation, the WDL for 1525 nm-1575 nm at attenuation 20 dB is about 0.8-1.4 dB. The is because the mode field diameter (MFD) of longer wavelength is larger than the MFD of shorter wavelength in the single mode fiber (SMF) so that the attenuation for longer wavelength is less than the attenuation for shorter wavelength on the same shift of the optical spot.

Several techniques are developed for WDL compensation, and the majority is based on material dispersion approach to cause, at a fixed attenuation value, the shift of optical spot with respect to optical fiber less than the shift of the longer wavelength to compensate MFD effect. For example, U.S. Pat. No. 7,574,096 and U.S. Pat. No. 8,280,218 use lens material with higher dispersion and changing the polishing angle of the dual fiber pigtail to compensate WDL. U.S. Pat. No. 7,295,748 uses a wedge to adjust the optical paths of different wavelengths. When the reflector is actuated to increase attenuation, the shift of optical spot with respect to optical fiber for shorter wavelength less than the shift for longer wavelength to compensate the WDL caused by the difference of MFD.

### SUMMARY

An exemplary embodiment describes a variable optical attenuator with wavelength-dependent loss compensation, including: an optical fiber pigtail, a lens, and a reflector, wherein the optical fiber pigtail having a pillar shape, with one end having a conic shape and connected to external optical fibers, and the other end being a slant surface facing the lens, further comprising at least a first waveguide for emitting a light and a second waveguide for receiving a returned light; the lens having a pillar shape with two end surfaces, disposed between the optical fiber pigtail and the reflector for focusing the emitted light from the first waveguide and returning the reflected light from the reflector to the second waveguide of the optical fiber pigtail; and the reflector being disposed at the focus of the lens to reflect the emitted light from the first waveguide passing the lens, and the reflected light passing through the lens to return to the second waveguide, the reflector having an initial position with a normal forming an pre-tilt angle with the axis of lens in the incident plane defined by the two axes, and the reflector tilting towards a larger tilt angle when an attenuation value increasing.

Another embodiment describes a variable optical attenuation with wavelength-dependent loss compensation, including a collimator, and a reflector, wherein the collimator having an optical fiber pigtail, and a lens; the optical fiber pigtail and the lens being fixed in a tubular housing, and the optical fiber pigtail further comprising at least a first waveguide and a second waveguide; the lens being for focusing the emitted light from the first waveguide and returning the reflected light from the reflector to the second waveguide of the optical fiber pigtail; the reflector being disposed at the focus of the lens to reflect the emitted light from the first waveguide passing the lens, and the reflected light passing through the lens to return to the second waveguide, the reflector having an initial position with a normal forming an pre-tilt angle with the axis of lens in the incident plane defined by the two axes, and the reflector tilting towards a larger tilt angle when an attenuation value increasing.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIGS. 1A and 1B show a schematic view of a variable optical attenuator with wavelength-dependent loss compensation, according to an exemplary embodiment;

FIGS. 2A and 2B show a schematic view of the variable optical attenuator in FIGS. 1A and 1B with the reflector tilting towards a larger tile angle when an attenuation value increases; and

FIGS. 3-7 show diagrams of WDL vs. attenuation given different pre-tilt angle θ for different lens material and focal length.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

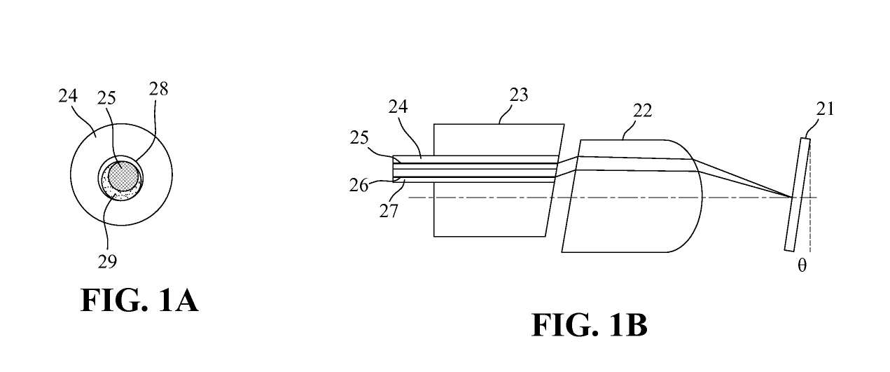

FIGS. 1A and 1B show a schematic view of a variable optical attenuator with wavelength-dependent loss compensation, according to an exemplary embodiment. As shown in FIG. 1B, the variable optical attenuator with wavelength-dependent loss compensation includes an optical fiber pigtail 23, a lens 22, and a reflector 21. The reflector 21 is driven by a MEMS actuator (not shown). The optical fiber pigtail 23 includes at least an emitting optical fiber 27 and an incident optical fiber 24, in which optical fiber 27 further includes an emitting optical fiber core 26 and optical fiber 24 further includes an incident optical fiber core 25. When a light from the emitting optical fiber 27 passes through the lens 22, the light is reflected by the MEMS-driven reflector 21. The axis of the lens 22 forms a pre-tilt angle θ with the normal of the lens 21 in the incident plane defined by the two axes. The reflected light enters the incident optical fiber 24 through the lens 22. In the minimum attenuation state as FIG. 1B, the reflected light is focused to form an optical spot 28 for the longer wavelength and to form an optical spot 29 for the shorter wavelength near the incident optical fiber core 25, as shown in FIG. 1A. Refer to FIG. 1A, The pre-tilt angle θ makes the optical spot 28 of the longer wavelength and the optical spot 29 of the shorter wavelength eccentric to compensate the WDL caused by difference in MFD. As shown in FIG. 1B, the lens 22 is disposed between the optical fiber pigtail 23 and the reflector 21.

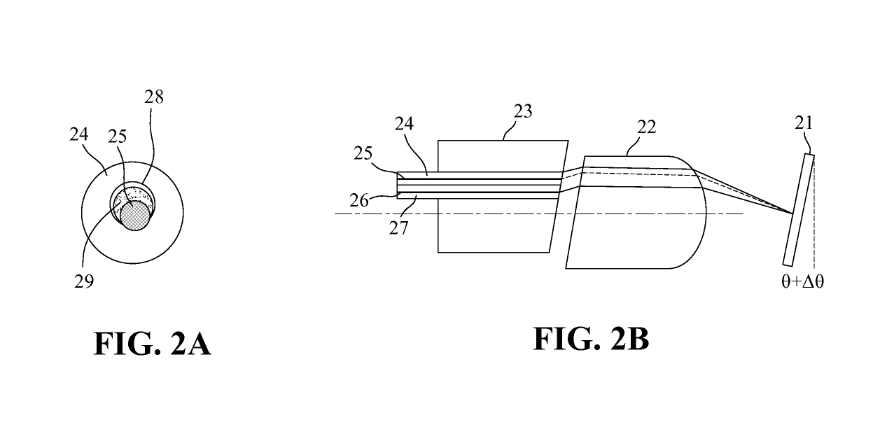

It should be noted that the optical fiber pigtail 23 includes at least a first waveguide (incident optical fiber) and a second waveguide (emitting optical fiber). The end of the optical fiber pigtail 23 facing the lens 22 is a slant surface forming a gap from a corresponding slant surface of the lens 22. The other end of the lens 22 has a dome shape facing the reflector 21. The reflector 21 is disposed with an initial position having a normal forming a pre-tilt angle with the axis of lens 22 in the incident plane defined by the two axes. For operation, the MEMS actuator drives the reflector 21 tilting towards a larger tilt angle when an attenuation value increases, as shown in FIG. 2B, where the normal of the reflector 21 forms a tilt angle of θ+Δθ with the axis of the lens 22 in the incident plane defined by the two axes.

As aforementioned, when the reflector is driven to cause a given attenuation as FIG. 2B, the reflector 21 is disposed with a position having a normal forming a tilt angle θ+Δθ with the axis of lens 22 in the incident plane defined by the two axes. The angle makes the shift of optical spot 29 for the shorter wavelength and the shift of optical spot 28 for the longer wavelength more eccentric to compensate the larger WDL caused by difference in MFD at larger attenuation value, as shown in FIG. 2A.

It should also be noted that the lens 22 can be embodied in various forms. For example, the lens 22 can be a convex lens, having a first end surface and a second end surface, and at least one of the two surfaces is a curve surface for focusing a light. The lens 22 can also be a C-lens, having a pillar shape with a first end surface and a second end surface, the first end surface is a slant surface and the second end surface is a curve surface, and the second end surface can focus a light. The lens 22 can also be a Grin lens, having an optical axis, with a refractive index changing along radial direction, and a light can be focused by the refractive index change.

Based on the MFD characteristics of the optical fiber and the material dispersion characteristics and the focus specification of the lens, the WDL can be optimized by adjusting the value of 0 given the selected attenuation range.

The spot size w is the half of MFD and is in a linear relation with the wavelength in a small wavelength range (e.g., C band or L band) and can be expressed as follows:

w=a+b*λ

where λ is the wavelength, a is a constant, and b is the linear chromatic dispersion coefficient. The most representative optical fiber is SMF-28e XB, which complied with ITU G657A standard for single mode optical fiber, with b having the value of 2.5 um/um. After exiting from the optical fiber, the energy of the light is in a Gaussian distribution. For the optimal coupling (not attenuated), the fiber core 25 on the slant surface of the optical fiber pigtail 23 is located at the back focus of the lens 22. When the reflector 21 rotates to cause the reflected light to shift with respect to the optical fiber core 25, the insertion loss change ΔIL can be expressed as follows:

ΔIL(λ)=4.34*[x/w(λ)]²

wherein x is the shift of the reflected light. The cause of the WDL is because different wavelength λ has different w (or MFD) and generates different ΔIL and WDL can be expressed as follows:

$$\begin{matrix}W D L = \frac{d ( Δ ( Δ I}{d λ} \cdot Δ λ \\ = 2 \cdot Δ IL \cdot ( \frac{1}{x} \frac{d x}{d λ} - \frac{1}{ω} \frac{d ω}{d λ} ) \cdot Δ λ \\ = 2 \cdot Δ IL \cdot ( \frac{- θ}{( n - 1 ) Δ )} \cdot \frac{d n}{d λ} - \frac{b}{ω} ) \cdot Δ λ\end{matrix}$$

wherein Δλ is a given bandwidth for estimating WDL, n is the lens's refractive index at central wavelength. In addition, dn/dλ is the chromatic dispersion of the refractive index near central wavelength and is a negative value for general materials. As equations above, the second term in the parentheses represents the intrinsic WDL caused by difference of MFD for different wavelengths and the first term is the compensating term caused by the shift of the reflected light for different wavelengths. In reality, the shift of optical spot with respect to the optical fiber for the shorter wavelength will be smaller than the shift for the longer wavelength, namely, the optical spot of the longer wavelength and shorter wavelength cause off-center effect to compensate the WDL caused by difference in MFD. Therefore, as long as the lens material shows dispersion characteristics and a proper pre-tilt angle θ of the reflector 21 is selected for a given attenuation range, the WDL can be optimized by compensating intrinsic WDL (second term) with the compensating term (first term). Furthermore, the larger the lens material dispersion (|dn/dλ|) is, the smaller the pre-tilt angle θ is required for WDL optimization.

The majority of lens material shows dispersion characteristics and the refractive index for the longer wavelength is smaller than the shorter wavelength (dn/dλ<0), for example, NSF11 used in C-lens, with refractive index n(1550 nm)=1.743, dn/dλ (1550 nm)=−0.0180 um⁻¹, and NPH2, with refractive index n(1550 nm)=1.861, dn/dλ(1550 nm)=−0.0247 um⁻¹, and less common Si, with refractive index n(1550 nm)=3.478, dn/dλ(1550 nm)=−0.0823 um⁻¹.

Based on the restriction of the pre-tilt angle and the size of the MEMS reflector, the suitable focal length of the lens can be determined. The curvature of the lens can also be determined for different material used. Regardless of the lens material and the focal length, the above adjustment of the pre-tilt angle θ can optimize the WDL for a given attenuation range by compensating MFD change with respect to wavelength.

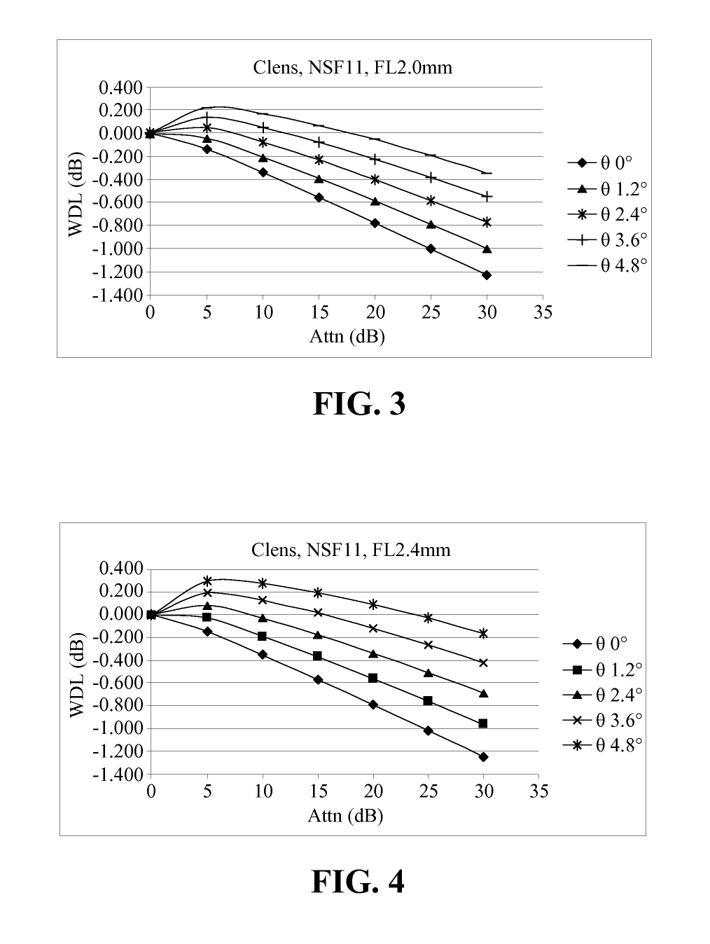

FIGS. 3-7 show diagrams of WDL vs. attenuation given different pre-tilt angle θ for different lens material and focal length. FIG. 3 shows a diagram of the change of WDL as the attenuation changes given different pre-tilt angle θ for a lens made of NSF11 with focal length (FL)=2.0 mm. As shown in FIG. 3, when the attenuation range is selected as 0-20 dB, and WDL (insertion loss at 1575 nm-insertion loss at 1525 nm) is required to be less than ±0.2 dB, the optimized value for 0 is about 3.8°. When the WDL is required to be less than ±0.3 dB, the available value for 0 ranges from 3.0° to 5.4°. The following figures shows the effect of different pre-tilt angle θ in the diagram of WDL vs. attenuation(range from 0 to 30 dB) for different lens material and focus length.

FIG. 4 shows a diagram of the change of WDL as the attenuation changes given different pre-tilt angle θ for a lens made of NSF11 with focus length (FL)=2.4 mm. When the attenuation range is selected as 0-20 dB, and WDL is required to be less than ±0.2 dB, the value for θ is about 3.5°.

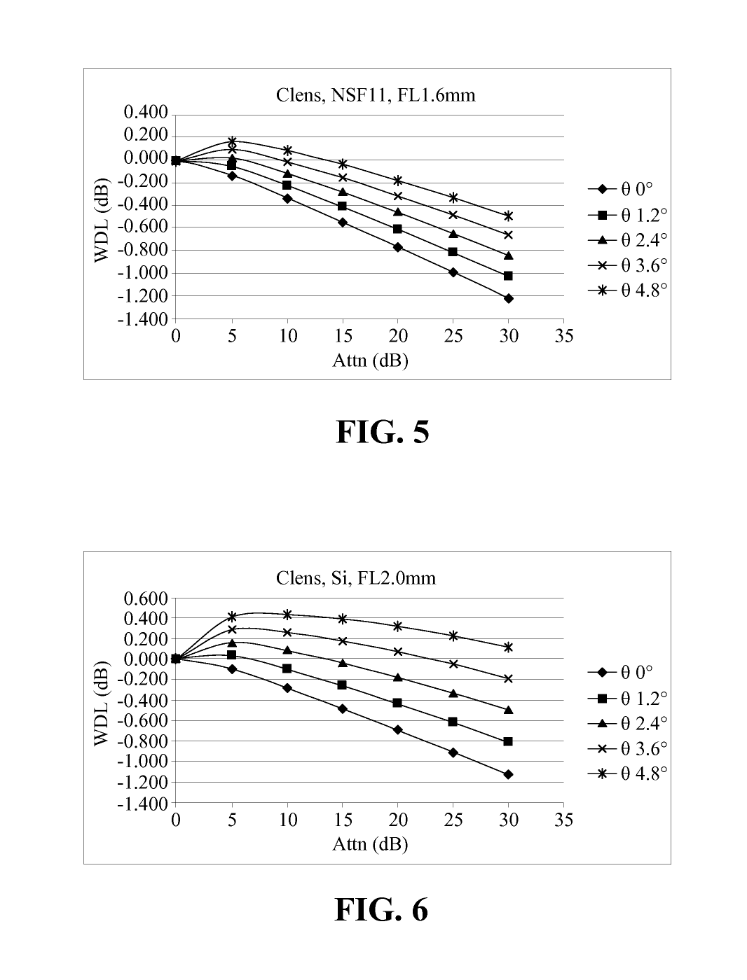

FIG. 5 shows a diagram of the change of WDL as the attenuation changes given different pre-tilt angle θ for a lens made of NSF11 with focus length (FL)=1.6 mm. When the attenuation range is selected as 0-20 dB, and WDL is required to be less than ±0.2 dB, the value for θ is about 4.8°.

FIG. 6 shows a diagram of the change of WDL as the attenuation changes given different pre-tilt angle θ for a lens made of Si with focus length (FL)=2.0 mm. When the attenuation range is selected as 0-20 dB, and WDL is required to be less than ±0.2 dB, the value for θ is about 2.4°.

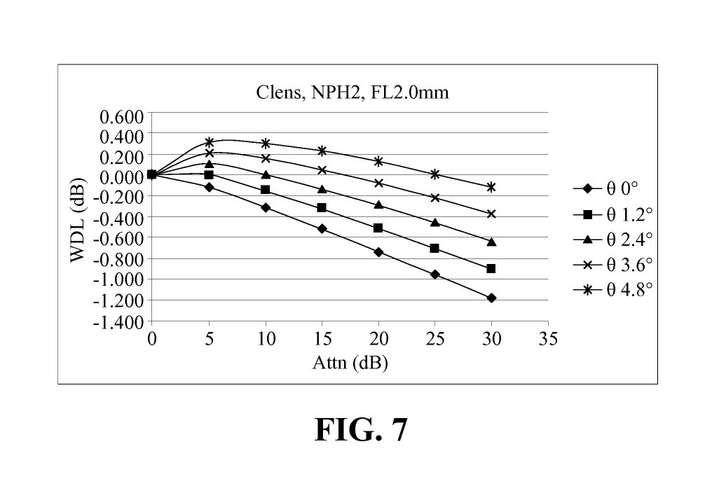

FIG. 7 shows a diagram of the change of WDL as the attenuation changes given different pre-tilt angle θ for a lens made of NPH2 with focus length (FL)=2.0 mm. When the attenuation range is selected as 0-20 dB, and WDL is required to be less than ±0.2 dB, the value for θ is about 3.0°.

As shown in the above figures, for the same lens material, the longer the FL is, the smaller the pre-tilt angle θ is required for WDL optimization. Similarly, For the same FL, the larger the lens material dispersion (|dn/dλ|) is, the smaller the pre-tilt angle θ is required for WDL optimization.

Therefore, in actual application, as long as the lens material and the FL are known, the pre-tilt angle θ required for WDL optimization can be determined. In addition, two approaches may be used to achieve making the collimator (composed of lens and optical fiber pigtail) with light-emitting direction forming a pre-tilt angle θ with the axis of the lens in the incident plane defined by the two axes. The first approach is to locate the optical fiber on the back focus, and then shift the optical fiber pigtail in the radial direction to achieve the required pre-tilt angle θ. The second approach is to adjust either the length of the lens or inclined angle of the slant surfaces of the pigtail and the lens to achieve the required emitting angle θ, and then dispose the optical fiber pigtail and the lens in a glass tube.

In actual application, the present invention can be embodied in two modes. The first mode is called normally open, or bright type, mode; and the second mode is called normally closed, or dark type, mode. The normally open mode is defined as follows: the attenuation value is the smallest when the reflector is not driven, and the normal of the reflector forms a tilt angle of θ. To increase attenuation value, the reflector is driven to tilt in the direction to form a tilt angle of θ+Δθ. On the other hand, the normally closed mode is defined as follows: the attenuation value is the largest when the reflector is not driven, and the normal of the reflector forms a tilt angle of θ+Δθ. To decrease attenuation value, the reflector is driven to tilt in the direction to form a tilt angle of θ. Whether bright or dark type, as long as the tilt of the reflector that makes attenuation is towards a larger angle in the incident plane defined by the axis of lens and the normal of the reflector, the wavelength-dependent loss can be compensated by the aforementioned approach. It should be noted that the said incident plane is not limited to specific direction as long as the pre-tilt angle of the reflector θ and the attenuation tilting angle Δθ are tilted both in the said incident plane.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A variable optical attenuator with wavelength-dependent loss compensation, comprising: an optical fiber pigtail, a lens, and a reflector;
wherein the optical fiber pigtail having a pillar shape, with one end having a conic shape and connected to external optical fibers, and the other end being a slant surface facing the lens, further comprising at least a first waveguide for emitting a light and a second waveguide for receiving a returned light;
the lens having a pillar shape with two end surfaces, disposed between the optical fiber pigtail and the reflector for focusing the emitted light from the first waveguide and returning the reflected light from the reflector to the second waveguide of the optical fiber pigtail; and
the reflector being disposed at the focus of the lens to reflect the emitted light from the first waveguide passing the lens, and the reflected light passing through the lens to return to the second waveguide, the reflector having an initial position with a normal forming a pre-tilt angle with the axis of lens in the incident plane defined by the two axes, and the reflector tilting towards a larger tilt angle when an attenuation value increasing.

2. The variable optical attenuator as claimed in claim 1, wherein the lens is a convex lens, having a first end surface and a second end surface, and at least one of the two surfaces is a curve surface for focusing a light.

3. The variable optical attenuator as claimed in claim 1, wherein the lens is a C-lens, having a pillar shape with a first end surface and a second end surface, the first end surface is a slant surface and the second end surface is a curve surface, and the second end surface can focus a light.

4. The variable optical attenuator as claimed in claim 1, wherein the lens is a Grin lens, having an optical axis, with a refractive index changing along radial direction, and a light can be focused by the refractive index change.

5. The variable optical attenuator as claimed in claim 1, wherein the normal of the reflector forming a pre-tilt angle with the axis of lens in the incident plane defined by the two axes, and the angle makes the shift of the optical spot with respect to the optical fiber for the shorter wavelength is smaller than the shift for the longer wavelength, that is, the optical spot of the longer wavelength and shorter wavelength cause off-center effect to compensate the WDL caused by difference in MFD.

6. The variable optical attenuator as claimed in claim 1, wherein the normal of the reflector forming a pre-tilt angle θ with the axis of lens in the incident plane defined by the two axes, and the range of θ is from 1° to 10°.

7. A variable optical attenuation with wavelength-dependent loss compensation, comprising: a collimator, and a reflector;
wherein the collimator having an optical fiber pigtail, and a lens; the optical fiber pigtail and the lens being fixed in a tubular housing, and the optical fiber pigtail further comprising at least a first waveguide and a second waveguide; the lens being for focusing the emitted light from the first waveguide and returning the reflected light from the reflector to the second waveguide of the optical fiber pigtail; and
the reflector being disposed at the focus of the lens to reflect the emitted light from the first waveguide passing the lens, and the reflected light passing through the lens to return to the second waveguide, the reflector having an initial position with a normal forming a pre-tilt angle with the axis of lens in the incident plane defined by the two axes, and the reflector tilting towards a larger tilt angle when an attenuation value increasing.

8. The variable optical attenuator as claimed in claim 7, wherein the lens is a C-lens, having a pillar shape with a first end surface and a second end surface, the first end surface is a slant surface and the second end surface is a curve surface, and the second end surface can focus a light.

9. The variable optical attenuator as claimed in claim 7, wherein the lens is a ball lens, and a light can be focused by the curve surface of the ball.

10. The variable optical attenuator as claimed in claim 7, wherein the lens is a Grin lens, having an optical axis, with a refractive index changing along radial direction, and a light can be focused by the refractive index change.

11. The variable optical attenuator as claimed in claim 7, wherein the normal of the reflector forming a pre-tilt angle with the axis of lens in the incident plane defined by the two axes, and the angle makes the shift of optical spot with respect to the optical fiber for the shorter wavelength is smaller than the shift for the longer wavelength, that is, the optical spot of the longer wavelength and shorter wavelength cause off-center effect to compensate the WDL caused by difference in MFD.

12. The variable optical attenuator as claimed in claim 7, wherein the normal of the reflector forming a pre-tilt angle θ with the axis of lens in the incident plane defined by the two axes, and the range of θ is from 1° to 10°.
